(19) United States
(12) Patent Application Publication
(10) Pub. No.: US 2007/0205179 A1
(43) Pub. Date: Sep. 6, 2007

(54) Manufacturing method of liquid crystal display device

(75) Inventor: Toshiharu Nishino, Hamura-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignees: CASIO COMPUTER CO., LTD., Tokyo (JP); SANWA FROST INDUSTRY CO., LTD., Tokyo (JP); NAGASE & CO., LTD., Osaka (JP)

(21) Appl. No.: 11/527,205

(22) Filed: Sep. 26, 2006

(30) Foreign Application Priority Data
Mar. 6, 2006 (JP) 2006-058940

(51) Int. Cl. C23F 1/00; B29D 11/00

(52) U.S. Cl. 216/24; 216/90

(57) ABSTRACT

A method of manufacturing a liquid crystal display device includes forming an assembly by sealing a gap between outer circumferential regions of two glass substrates, which are positioned to face each other, with an outer circumferential sealing member. The assembly is dipped in an etching solution contained in an etching vessel, thereby etching the two glass substrates of the assembly for a time corresponding to a predetermind etching thickness of each of the two glass substrates, so as to decrease the thickness of each of the two glass substrates, while the temperature and the concentration of the etching solution contained in the etching vessel are maintained constant.

### CROSS-REFERENCE TO RELATED APPLICATIONS

This application is based upon and claims the benefit of priority from prior Japanese Patent Application No. 2006-058940, filed Mar. 6, 2006, the entire contents of which are incorporated herein by reference.

### BACKGROUND OF THE INVENTION

1. Field of the Invention

The present invention relates to a method of manufacturing a liquid crystal display device.

2. Description of the Related Art

A conventional method of manufacturing a liquid crystal display device is disclosed in, for example, U.S. Pat. No. 6,197,209. It is disclosed that two glass substrates are bonded to each other with a frame sealing member interposed therebetween. In the prior art disclosed in the U.S. patent document quoted above, the frame sealing member is arranged to surround those regions of the two glass substrates in which the individual display elements are formed, followed by sealing the outer peripheral portions of the two glass substrates, which are bonded to each other, with an outer circumferential sealing member. Under this condition, the glass substrates are dipped in an etching solution contained in an etching vessel so as to etch the two glass substrates, thereby decreasing the thickness of each of the two glass substrates.

In the conventional method of manufacturing a liquid crystal display device described above, the temperature of the etching solution contained in the etching vessel is elevated with progress of the etching treatment of the glass substrate, i.e., with increase in the etched amount of the glass substrate. Therefore, the temperature of the etching solution contained in the etching vessel is detected, and the end point of the etching treatment is determined based on the detected temperature of the etching solution, thereby controlling the glass substrate to have a desired thickness.

It should be noted that, in this etching treatment, the etching rate is changed depending on the temperature and the concentration of the etching solution contained in the etching vessel. Therefore, if the initial temperature and the initial concentration of the etching solution in the etching vessel are changed, the critical temperature, i.e., the temperature of the etching solution in the etching vessel at the end point of the etching treatment, which is to cause the glass substrate to be etched to have a desired thickness, is changed depending on the initial temperature and the initial concentration of the etching solution in the etching vessel.

It should also be noted that, in order to improve the productivity of the liquid crystal display devices in the general method of manufacturing a liquid crystal display device, an assembly for forming a plurality of liquid crystal display devices is prepared in many cases by bonding two glass substrates each having an area large enough to form therein a plurality of finished liquid crystal display devices. These two glass substrates are bonded to each other with a plurality of frame sealing members interposed therebetween. Also, a batch processing is applied in many cases to a plurality of the assemblies noted above each having the two glass substrates bonded to each other.

In the batch processing noted above, the plural assemblies for forming the liquid crystal display devices are dipped simultaneously in the etching solution contained in the etching vessel so as to carry out the etching treatment. In this case, the temperature elevation of the etching solution in the etching vessel, which is caused by the progress of the etching treatment, is changed depending on the number of assemblies for forming the liquid crystal display devices which are dipped simultaneously in the etching solution in the etching vessel for the batch processing. The change in the temperature elevation noted above brings about a change in the critical temperature noted above that is provided by the temperature of the etching solution in the etching vessel at the end point of the etching treatment, which is to permit the glass substrate to have a desired thickness.

As described above, the critical temperature noted above is changed depending on the initial temperature and the initial concentration of the etching solution contained in the etching vessel and on the number of assemblies for forming the liquid crystal display devices that are dipped simultaneously in the etching solution for carrying out the batch processing. Such being the situation, preliminary tests are carried out in view of these parameters so as to determine the critical temperature that is provided by the temperature of the etching solution in the etching vessel at the end point of the etching treatment, i.e., the critical temperature that is to permit the glass substrate to have a desired thickness.

However, the total number of parameters including the initial temperature and the initial concentration of the etching solution contained in the etching vessel and the number of assemblies for forming the liquid crystal display devices, which are dipped simultaneously in the etching solution for carrying out the batch processing, is equal to the product of the numbers of the individual independent parameters noted above. Therefore, in the case of employing the particular technology, it is necessary to carry out a large number of preliminary tests and, thus, voluminous operations are deemed necessary. In addition, the relationship between the temperature of the etching solution and the etched amount of the glass substrate is considered to be changed by the change in the inner volume of the etching vessel. The relationship noted above is also considered to be changed in the case where the amount of the etching solution used in the etching treatment differs from that in the preliminary test. Such being the situation, it is necessary to carry out a large number of the preliminary tests described above for each etching apparatus, giving rise to the problem that the number of required operations is further increased.

### BRIEF SUMMARY OF THE INVENTION

Under the circumstances, the present invention is intended to provide a method of manufacturing a liquid crystal display device, which permits decreasing the number of parameters required for determining the end point of the etching treatment that is carried out for decreasing as desired the thickness of each of two glass substrates bonded to each other.

According to a first aspect of the present invention, there is provided a method of manufacturing a liquid crystal display device, comprising:

forming at least one assembly by sealing a gap between outer circumferential regions of two glass substrates, which are positioned to face each other, with an outer circumferential sealing member;

dipping said at least one assembly in an etching solution contained in an etching vessel; and

etching the two glass substrates of the assembly for a time corresponding to a predetermind etching thickness of each of the two glass substrates, so as to decrease the thickness of each of the two glass substrates, while the temperature and the concentration of the etching solution contained in the etching vessel are maintained constant.

### BRIEF DESCRIPTION OF THE SEVERAL VIEWS OF THE DRAWING

FIG. 1A is a plan view exemplifying the construction of a liquid crystal display device manufactured by the manufacturing method according to one embodiment of the present invention;

FIG. 1B is a cross-sectional view along the line 1B-1B shown in FIG. 1A;

FIG. 2 is a flowchart showing the manufacturing process of the liquid crystal display device shown collectively in FIGS. 1A and 1B;

FIG. 3 is a perspective plan view, partly broken away, showing the construction of the liquid crystal display device, and intended to explain the manufacturing steps S1 to S4 shown in FIG. 2;

FIG. 4 is a view for schematically showing an example of the construction of an etching apparatus;

FIG. 5 shows as an example the construction of a main portion of an electric circuit of a conductivity meter;

FIG. 6 is a perspective view for showing an example of a main portion of another conductivity meter;

FIG. 7 is a graph showing the relationship between the thickness of the etched glass substrate and the etching time; and

FIG. 8 schematically shows as another example of the etching apparatus.

### DETAILED DESCRIPTION OF THE INVENTION

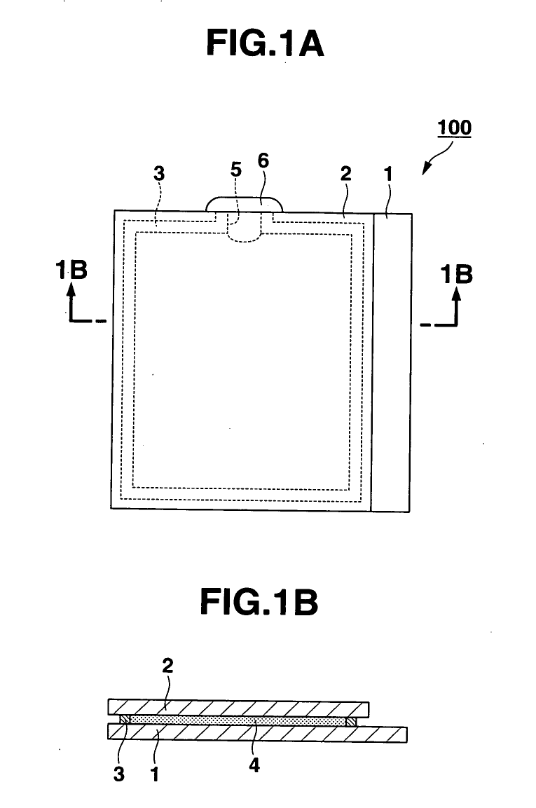

FIG. 1A is a plan view exemplifying the construction of a liquid crystal display device 100 manufactured by the manufacturing method according to one embodiment of the present invention; and FIG. 1B is a cross-sectional view along the line 1B-1B shown in FIG. 1A. As shown in the figures, the liquid crystal display device 100 comprises two glass substrates 1 and 2, which are bonded to each other with a plurality of substantially rectangular frame sealing members 3 interposed therebetween. A liquid crystal 4 is introduced into a space or gap between the glass substrates 1 and 2 inside each of the frame sealing members 3 through a liquid crystal injection port 5 formed in the frame-like sealing member 3. After the liquid crystal 4 is introduced into the space enclosed by the seal 3, the liquid crystal injection port 5 is sealed with a sealing member 6. It should be noted that one side portion of the glass substrate 1 on the lower side protrudes in a horizontal direction from the side edge of the glass substrate 2 on the upper side. Also, each of the glass substrates 1 and 2 has a relatively small thickness. For example, the thickness of each of the glass substrates 1 and 2 is set at 0.3 mm.

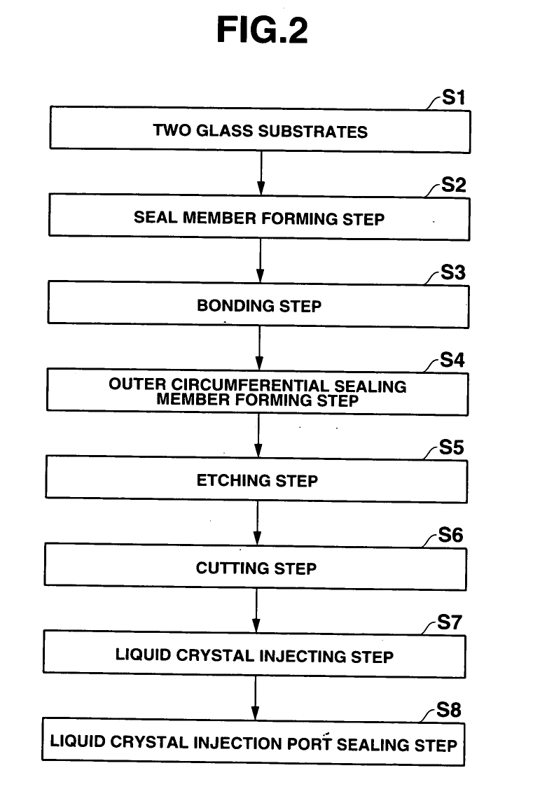

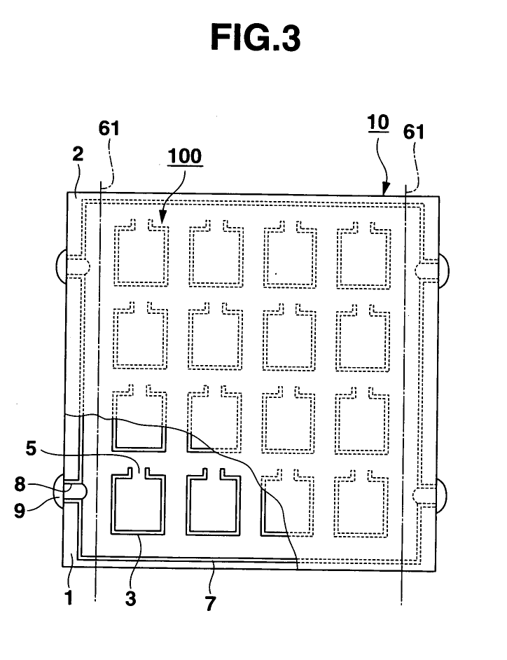

An example of the manufacturing method of the liquid crystal display device 100 will now be described with reference to the flowchart shown in FIG. 2. In manufacturing step S1 shown in FIG. 2, two glass substrates 1 and 2 are prepared each having an area large enough to permit a plurality of finished liquid crystal display devices 100 to be formed therein. In the example shown in FIG. 3, each of the glass substrates 1 and 2 has an area large enough to permit 16 finished liquid crystal display devices 100, i.e., 4 (rows)×4 (columns), to be formed therein. In this case, each of the glass substrates 1 and 2 before the etching treatment described herein after has a relatively large thickness, e.g., a thickness of 0.5 mm.

Then, in the forming process of the frame sealing members in manufacturing step S2 shown in FIG. 2, a plurality of substantially rectangular frame-like frame sealing members 3 each made of an epoxy series resin are formed by a screen printing method in the forming regions of the liquid crystal display devices 100 on the upper surface of the glass substrate 1 on the lower side. In this example, 16 frame sealing members 3 (4 rows×4 columns) are formed. At the same time, a substantially rectangular frame-like outer circumferential sealing member 7, which is also made of an epoxy series resin, is formed in the outer circumferential portion on the upper surface of the glass substrate 1 on the lower side. In this case, the liquid crystal injection port 5 is formed in one portion of each of the frame sealing-members 3, and air releasing ports 8 are formed in four portions of the outer circumferential sealing member 7.

Then, in bonding step S3, the upper glass substrate 2 is superposed on the lower glass substrate 1. Under this condition, the respective frame sealing members 3 and the outer circumferential sealing member 7 are heated so as to be cured, thereby allowing the two glass substrates 1 and 2 to be bonded to each other with the frame sealing members 3 and the outer circumferential sealing member 7 interposed therebetween. In this case, the air present in the space between the glass substrates 1 and 2 within the outer circumferential sealing member 7 is thermally expanded. The expanded air is partly released to the outside through the air releasing ports 8 formed in the outer circumferential sealing member 7 so as to prevent the outer circumferential sealing member 7 from being broken.

In the subsequent process of forming the outer circumferential sealing member 7 in manufacturing step S4 of the liquid crystal display device shown in FIG. 2, each of the air releasing ports 8 formed in the outer circumferential sealing member 7 is sealed with a sealing member 9 made of an epoxy modified acrylic resin that can be cured by an ultraviolet light. FIG. 3 shows the state after the forming process of the sealing members 9 in the manufacturing step S4 of the liquid crystal display device shown in FIG. 2. The assembly of the state shown in FIG. 3 is called herein an assembly 10 for forming a plurality of the liquid crystal display devices 100.

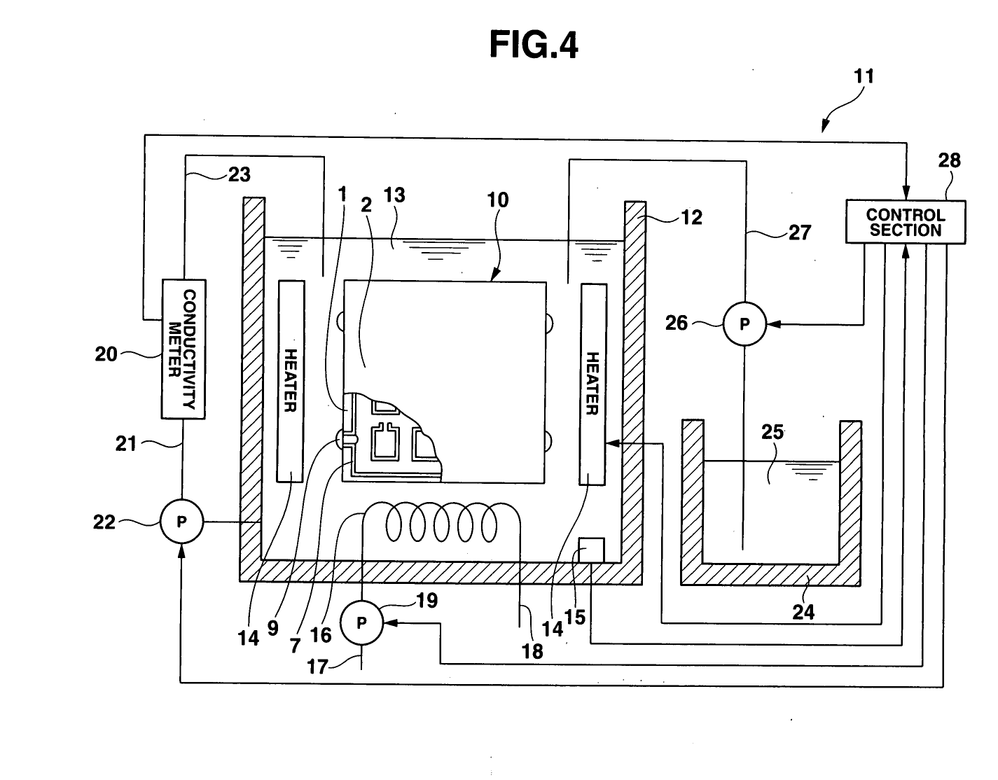

Further, in order to carry out the etching step S5 shown in FIG. 2, prepared is an etching apparatus 11 that is schematically constructed as shown in FIG. 4. As shown in the figure, the etching apparatus 11 includes an etching vessel 12. Contained in the etching vessel 12 as an etching solution of glass is a hydrofluoric acid series aqueous solution 13 containing hydrofluoric acid, water and a catalyst for promoting the etching reaction.

A heater 14, a temperature sensor 15, for example, a thermocouple, and a cooling pipe 16 in the form of a coil are arranged in the etching vessel 12. The inlet side and the outlet side of the cooling pipe 16 are connected, respectively, to an inlet side pipe 17 and an outlet side pipe 18, which are arranged outside the etching vessel 12. Also, a cooling water pump 19 is arranged in the inlet side pipe 16.

A conductivity meter 20 is also arranged outside the etching vessel 12. The construction of the conductivity meter 20 will be described herein after. It should be noted that, since the electrical conductivity of the etching solution 13 is related to the concentration of the hydrofluoric acid contained in the etching solution 13, the concentration of the hydrofluoric acid contained in the etching solution 13 can be detected by measuring the electrical conductivity of the etching solution 13.

One end portion of a sampling pipe 21 is connected to a lower portion of the conductivity meter 20. Also, the other end portion of the sampling pipe 21 is connected to a lower portion of the etching vessel 12. Further, a sampling pump 22 is provided on the sampling pipe 21. One end portion of an etching solution recovery pipe 23 is connected to an upper portion of the conductivity meter 20, and the other end portion of the recovery pipe 23 is arranged in an upper portion within the etching vessel 12.

A replenishing tank 24 is arranged outside the etching vessel 12. Hydrofluoric acid solution 25 is contained in the replenishing tank 24. The hydrofluoric acid solution 25 in the replenishing tank 24 is supplied into the etching vessel 12 through a replenishing pipe 27 by driving a replenishing pump 26 provided to the replenishing pipe 26.

The temperature sensor 15 detects the temperature of the etching solution 13 contained in the etching vessel 12 and supplies the temperature detection signal to a control section 28. On the other hand, the conductivity meter 20 detects the electrical conductivity of the etching solution 13 supplied into the conductivity meter 20 and supplies a conductivity (concentration) detection signal to the control section 28. The control section 28 carries out arithmetic operations described herein after based on the temperature detection signal and conductivity detection signal, and controls the driving of the heater 14 and each of the pumps 19, 22 and 26.

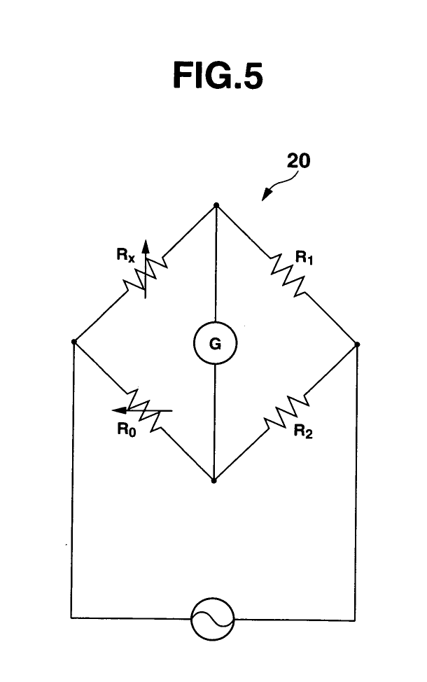

FIG. 5 shows as an example the construction of a main portion of the electric circuit of the conductivity meter 20. The electric circuit is formed of a resistance measuring circuit of the Wheatstone bridge including a resistance Rx of the measuring object, i.e., the etching solution 13, an internal variable resistor R₀, internal stationary resistors (resistances) R₁, R₂, and a galvanometer G, which are connected to each other in the form of a bridge. In this case, R₁ is equal to R₂, i.e., R₁=R₂.

In the conductivity meter 20, a preliminary test is carried out first by controlling the internal variable resistor R₀ so as to permit the current I flowing within the galvanometer G to be zero (0) under the state that an etching solution for an experiment having a known value of the resistance R₁ is supplied into the conductivity meter 20. As a result, the resistance R₀ is made equal to the resistance R₁, i.e., R₀=R₁. If the etching solution 13 to be measured is supplied into the conductivity meter 20 in the next step under the state that R₀ is equal to R₁, i.e., R₀=R₁, the current flowing within the galvanometer G is changed into I. In this stage, the current i of the same magnitude flows through each of the resistors R₁ and R₂. It should be noted that the change AR of the resistance of the resistor Rₓ is substantially proportional to the current I when I/i is sufficiently smaller than 1. Therefore, the resistance of the etching solution 13 to be measured can be obtained from the equation of Rₓ=R₀+ΔR. It follows that it is possible to obtain the resistivity and the conductivity, which is a reciprocal of the resistivity, of the etching solution 13 as described herein after.

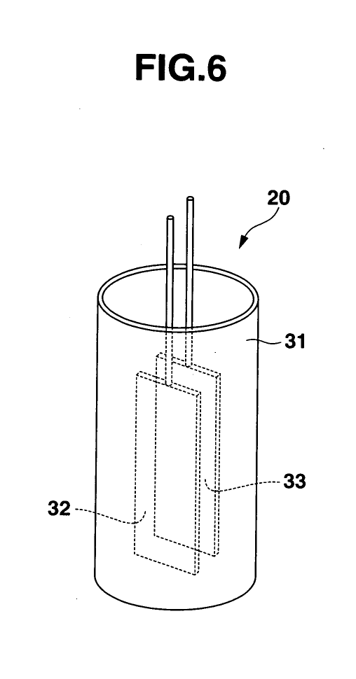

FIG. 6 is an oblique view showing a main part of an aconductivity meter 20 which is an example of means for measuring the resistance Rₓ of the measuring object As shown in the figure, the conductivity meter 20 includes a cylindrical case 31 formed of, for example, a fluorocarbon resin and a pair of strip-like electrodes 32 and 33 each formed of platinum, carbon, etc. and arranged within the case 31 in a manner to face each other. If an electric current is allowed to flow between the paired electrodes 32 and 33 under the state that the etching solution 13 is supplied into the case 31, it is possible to measure the resistance of the etching solution 13 interposed between the paired electrodes 32 and 33 in accordance with the Ohm's law. In this case, the conductivity κ can be obtained from formula (1) given below. In formula (1) given below, ρ denotes the resistivity of the etching solution 13, R denotes the resistance of the measured etching solution, D denotes the distance between the paired electrodes 32 and 33, and S denotes the mutually facing area of the electrodes 32 and 33.

κ=1/ρ=D/(RS) (1)

The temperature control of the etching solution 13 contained in the etching vessel 12 of the etching apparatus 11 shown in FIG. 4 will now be described. If the temperature of the etching solution 13 in the etching vessel 12 is detected by the temperature sensor 15, the temperature detection signal is supplied to the control section 28. Then, the control section 28 judges whether or not the temperature of the etching solution 13 in the etching vessel 12 is lower than a prescribed set temperature (e.g., 60±1° C.) based on the temperature detection signal supplied from the temperature sensor 15. Where the temperature of the etching solution 13 in the etching vessel 12 is judged to be lower than the prescribed set temperature noted above, the control section 28 drives the heater 14 so as to heat the etching solution 13 in the etching vessel 12 to the prescribed set temperature.

On the other hand, where the temperature of the etching solution 13 contained in the etching vessel 12 has been elevated in accordance with progress of the etching treatment so as to be made higher than the prescribed set temperature, the control section 28 judges that the temperature of the etching solution 13 contained in the etching vessel 12 has been made higher than the prescribed set temperature and drives the cooling water pump 19 so as to supply a cooling water into the cooling water pipe 16. As a result, the etching solution 13 within the etching vessel 12 is cooled so as to permit the temperature of the etching solution 13 in the etching vessel 12 to be made equal to the prescribed set temperature.

Particularly, it is also possible to control the driving of the heater 14 by the proportional integral differential (PID) control method. In the PID control method, the driving of the heater 14 can be controlled by employing the proportional control, the integral control and the differential control in combination so as to make it possible to realize a delicate and smooth control. Particularly, the temperature of the etching solution 13 contained in the etching vessel 12 can be brought back to the prescribed set temperature in a short time in the case where the temperature of the etching solution 13 in the etching vessel 12 is rapidly lowered by the disturbance including, for example, the dipping of the assembly 10 for forming the liquid crystal display devices in the etching solution 13 or the supply of the hydrofluoric acid solution into the etching vessel 12 as described herein after.

The control in the concentration of the etching solution 13 contained in the etching vessel 12 will now be described. If the sampling pump 22 is driven, the etching solution 13 in the etching vessel 12 is supplied into the conductivity meter 20 through the sampling pipe 21. It should be noted that the etching solution 13 continues to flow in the conductivity meter 20 at a substantially constant flow rate during the driving of the sampling pump 22 so as to be recovered in the etching vessel 12 through the etching solution recovery pipe 23.

In the conductivity meter 20, the electrical conductivity of the etching solution 13 supplied thereinto is detected and the result of the detection of the electrical conductivity is supplied from the conductivity meter 20 into the control section 28. Then, the control section 28 judges whether or not the concentration of hydrofluoric acid in the etching solution 13 is lower than the prescribed set concentration based on the result of detection of the electrical conductivity supplied from the conductivity meter 20. Where the concentration of hydrofluoric acid in the etching solution 13 is judged to be lower than the prescribed set concentration, the replenishing pump 26 is driven to supply the hydrofluoric acid solution 25 contained in the replenishing tank 24 into the etching vessel 12 through the replenishing pipe 27, thereby allowing the hydrofluoric acid concentration of the etching solution 13 in the etching vessel 12 to be made equal to the prescribed set concentration.

For example, where the etching solution 13 is formed of a hydrofluoric acid-based aqueous solution made of 80% of hydrofluoric acid, 15% of water and 5% of other components such as a catalyst for promoting the etching reaction, the hydrofluoric acid concentration of the etching solution 13 is 80%. Also, the prescribed set concentration of hydrofluoric acid is 80±4% including the tolerance. In this case, the operation of the replenishing pump 26 is automatically stopped when the hydrofluoric acid solution 25 is supplied into the etching vessel 12 in an amount that is determined based on the experimental data.

The operation of the etching apparatus shown in FIG. 4 will now be described. In this case, a single assembly 10 for forming the liquid crystal display devices is dipped in the etching solution 13 contained in the etching vessel 12 under the state that the temperature and the concentration of the etching solution 13 in the etching vessel 12 are respectively set at a prescribed temperature and a prescribed concentration. As a result, the two glass substrates 1 and 2 forming the assembly 10 are etched so as to cause the thickness of each of the glass substrates 1 and 2 to be decreased gradually.

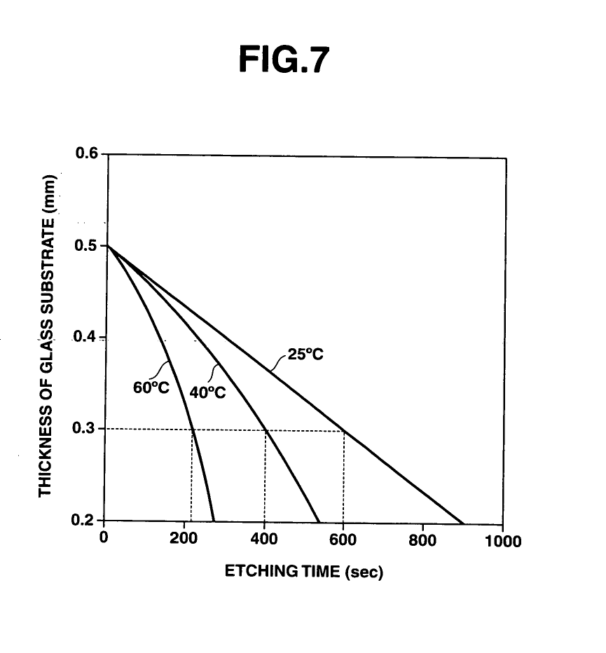

The result of the preliminary test will now be described. The glass substrates 1 and 2 of the assembly 10 were etched under the state that the hydrofluoric acid concentration of the etching solution 13 contained in the etching vessel 12 was set constant at 80±4% and that the temperature of the etching solution 13 in the etching vessel 12 was set constant at 60° C., 40° C. or 25° C. each including the tolerance of ±1° C. so as to examine the relationship between the thickness of the etched glass substrate and the etching time. FIG. 7 is a graph showing the experimental data. In this preliminary test, each of the glass substrates 1 and 2 had an initial thickness of about 0.5 mm before the etching treatment. Incidentally, the etching rate in this preliminary test was dependent on the temperature and the concentration of the etching solution 13. Therefore, even in the batch processing in which a plurality of the assemblies 10 for forming the liquid crystal display devices are etched simultaneously, the etching rate of each of the two glass substrates forming each of the plural assemblies 10 for forming the liquid crystal display devices is made equal to the etching rate of each of the two glass substrates forming the single assembly 10 for forming the liquid crystal display devices, which was subjected to the preliminary test referred to above.

In obtaining the experimental data given in the graph of FIG. 7, the temperature of the etching solution 13 in the etching vessel 12 was set constant at 60° C., 40° C. or 25° C. Also, the experiment was conducted under the state that the hydrofluoric acid concentration of the etching solution 13 in the etching vessel 12 was set constant at 80±4%. As apparent from the graph of FIG. 7, the thickness of each of the etched glass substrates 1 and 2 was determined solely by the etching time in any temperature condition of the etching solution 13, though the etching rate was increased with increase in the temperature of the etching solution 13.

In the experiment relating to the graph of FIG. 7, the etching treatment was intended to decrease the thickness of each of the glass substrates 1 and 2 of the assembly 10 for forming the liquid crystal display devices from the initial thickness of about 0.5 mm to about 0.3 mm. In this experiment, the temperature of the etching solution 13 in the etching vessel 12 was set constant at 60° C., 40° C. or 25° C. Where the assembly 10 for forming the liquid crystal display devices was taken out of the etching solution 13 in the etching vessel 12 after the etching time of about 210 seconds, about 400 seconds or about 600 seconds, the thickness of each of the glass substrates 1 and 2 was decreased from the initial thickness of about 0.5 mm to about 0.3 mm in each of the cases where the temperatures of the etching solution 13 were set as pointed out above.

In the example described above, the temperature and the concentration of the etching solution 13 contained in the etching vessel 12 were maintained constant, and the etching amount of each of the glass substrates 1 and 2 forming the assembly 10 for forming the liquid crystal display devices was controlled by controlling the etching time. In short, the etching time alone provides the parameter for controlling the etching amount of each of the glass substrates 1 and 2 so as to make it possible to decrease the number of parameters required for determining the end point of the etching treatment that is performed for decreasing the thickness of each of the glass substrates 1 and 2. It follows that it is possible to decrease the number of preliminary tests.

To be more specific, where the temperature of the etching solution 13 contained in the etching vessel 12 is set at 60±1° C., it is possible to obtain the result shown in FIG. 7 covering the case where the temperature is set at 60° C., if a preliminary test is conducted once under the state that the hydrofluoric acid concentration of the etching solution 13 in the etching vessel 12 is set at 80±4%. Where the temperature of the etching solution 13 is set at 40±1° C. or 25±1° C., it suffices to conduct an additional preliminary test. In this fashion, the number of preliminary tests can be decreased.

As described above, where a plurality of assemblies 10 for forming the liquid crystal display devices are simultaneously subjected to the batch processing, the etching rate of each of the two glass substrates of each of the plural assemblies 10 for forming the plural liquid crystal display devices is equal to the etching rate of each of the two glass substrates forming the 10 and used in the preliminary test described above. It follows that the number of preliminary tests can also be decreased in the case of the batch processing noted above, too. It should also be noted that the etching amount of the glass substrates 1, 2 forming the assembly 10 can be controlled by controlling the etching time or period even in the case where the etching vessel has a different inner volume or where the amount of the etching solution used for the etching treatment differs from that in the preliminary test. It follows that it is unnecessary to conduct a preliminary test for each etching vessel.

After the thickness of each of the glass substrates 1 and 2 of the assembly 10 is decreased sufficiently, the assembly 10 is taken out of the etching solution 13 contained in the etching vessel 12, thereby finishing the etching treatment. In cutting step as shown in FIG. 2, the glass substrates 1 and 2 of the assembly 10 are cut away along cutting lines 61 shown in FIG. 3 by a cutting means such as a glass cutter so as to remove the sealing members 9 sealing the air releasing ports 8 from the assembly 10. Then, the glass substrates 1 and 2 having no sealing members 9 are cut along the space between the adjacent frame sealing members 3 and along the space between the frame sealing members 3 and the outer circumferential sealing member 7 so as to form individual liquid crystal display devices.

It should be noted that the sealing members 9 are formed after the glass substrates 1 and 2 are bonded to each other with the frame sealing members 3 interposed therebetween. Therefore, the sealing members 9 are formed to project partly from the edges of the glass substrates 1 and 2. Therefore, in the cutting step described above, the sealing members 9 are removed before the glass substrates 1 and 2 are cut into the individual liquid crystal display devices. Thus, it follows that it is possible to prevent the unintentional defective cutting that brings about, for example, the cracking of the glass substrates 1 and 2 in the step of cutting the glass substrates 1 and 2. It should be noted that, if the sealing members 9 are not removed from the-glass substrates 1 and 2 before the cutting step of the glass substrates 1 and 2 into the individual liquid crystal display devices, it is possible for the blade portion of the glass cutter to abut against the sealing member 9 so as to lower the pressure directed away from or applied to the glass substrates 1 and 2 and, thus, to make the edge portions of the glass substrates 1 and 2 unlikely to be cut away. It follows that, if the sealing members 9 are removed before the cutting step of the glass substrates into the individual liquid crystal display devices as in the present invention, it is possible to prevent the unintentional defective cutting noted above such as the cracking, which is brought about in the case where it is difficult to cut away the edge portions of the glass substrates 1 and 2, from being brought about in the cutting step of the glass substrates 1 and 2 into the individual liquid crystal display devices.

In the subsequent liquid crystal injecting step S7 shown in FIG. 2, the liquid crystal 4 is injected into the space between the glass substrates 1 and 2 inside the frame sealing member 3 through the liquid crystal injection port 5 formed in the frame sealing member 3, followed by sealing the liquid crystal injection port 5 with the sealing member 6 in the sealing step S8 of the liquid crystal injection port 5 shown in FIG. 2, thereby obtaining the liquid crystal display device 100 shown in FIGS. 1A and 1B.

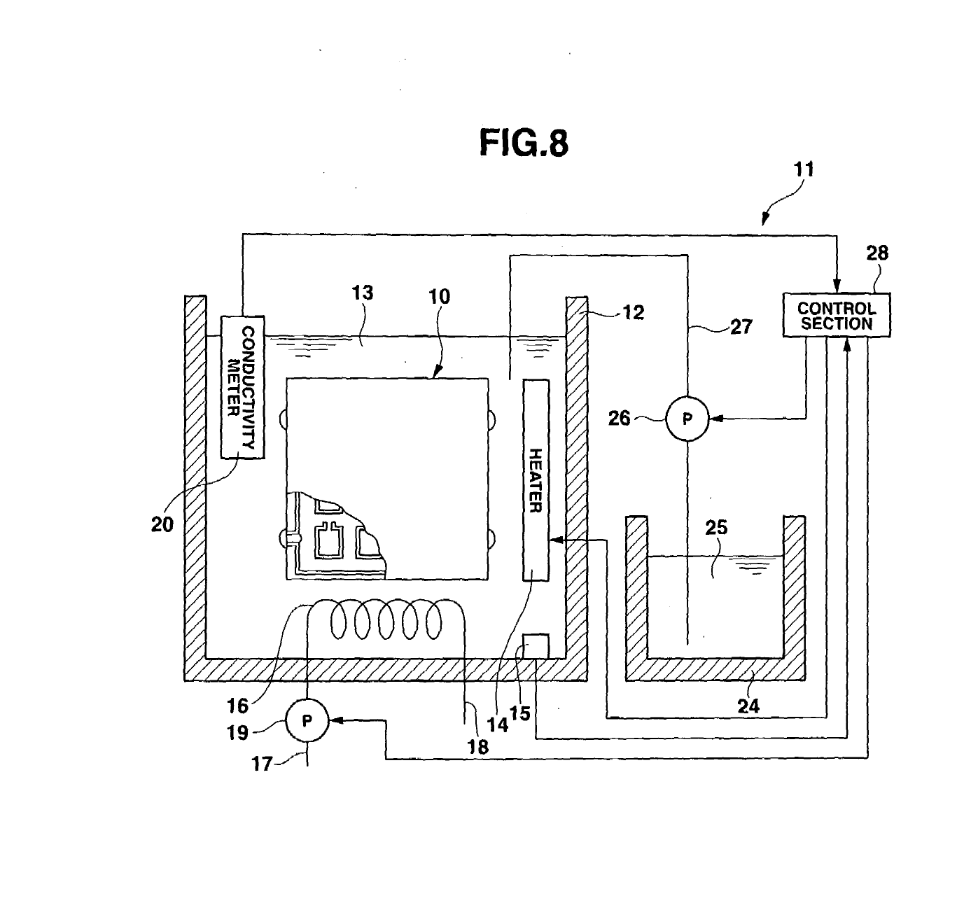

FIG. 8 schematically shows another example of the construction of the etching apparatus 11. The etching apparatus 11 shown in FIG. 8 differs from the etching apparatus 11 shown in FIG. 4 in that the conductivity meter 20 is arranged within the etching solution 13 contained in the etching vessel 12 so as to omit the sampling pipe 21, the sampling pump 22, and the etching solution recovery pipe 23 included in the etching apparatus 11 shown in FIG. 4. Since the sampling pipe 21, the sampling pump 22, and the etching solution recovery pipe 23 are omitted, the construction can be simplified in the etching apparatus 11 shown in FIG. 8.

In the etching apparatus shown in each of FIGS. 4 and 8, it is possible to vibrate or rock the etching vessel 12 in vertical direction and/or horizontal direction by using a mechanical or electrical rocking means (not shown) so as to carry out the etching treatment while moving the etching solution 13 in the etching vessel 12. In this case, it is possible to make uniform the temperature and the concentration of the etching solution 13 in the etching vessel 12 more easily.

Also, in the etching apparatus 11 shown in each of FIGS. 4 and 8, it is possible to carry out the etching treatment while vibrating only the etching solution 13 contained in the etching vessel 12, for example, by using an ultrasonic vibrating means (not shown). In this case, it is possible to prevent the etching treatment from being locally delayed by the bubbles generated within the etching vessel 12 by the etching treatment and attached to the surfaces of the glass substrates 1 and 2. It is also possible to remove easily the stains formed of the organic materials and attached to the surfaces of the glass substrates 1 and 2.

According to the present invention, attentions are paid to the aspect that the etching rate is determined solely by the temperature and the concentration of the etching solution contained in the etching vessel, and the etched amounts of the glass substrates bonded to each other are controlled by the etching time by maintaining constant the temperature and the concentration of the etching solution in the etching vessel. It follows that the etching time alone provides the parameter required for determining the etched amount of the glass substrate. In other words, in order to carry out an etching treatment for achieving the object of decreasing as desired the thickness of each of the glass substrates bonded to each other, the present invention makes it possible to decrease the number of parameters required for determining the end point of the etching treatment.

What is claimed is:

1. A method of manufacturing a liquid crystal display device, comprising:
forming at least one assembly by sealing a gap between outer circumferential regions of two glass substrates, which are positioned to face each other, with an outer circumferential sealing member;
dipping said at least one assembly in an etching solution contained in an etching vessel; and
etching the two glass substrates of the assembly for a time corresponding to a predetermind etching thickness of each of the two glass substrates, so as to decrease the thickness of each of the two glass substrates, while the temperature and the concentration of the etching solution contained in the etching vessel are maintained constant.

2. The method of manufacturing a liquid crystal display device according to claim 1, wherein the etching includes:
detecting the temperature of the etching solution contained in the etching vessel by using a temperature detector; and
controlling the temperature of the etching solution by heating with a heater or by the cooling with a cooler, based on the result of the temperature detection to maintain the temperature of the etching solution constant.

3. The method of manufacturing a liquid crystal display device according to claim 1, wherein:
the etching solution includes an aqueous solution of hydrofluoric acid; and
the etching includes detecting the concentration of the hydrofluoric acid in the etching solution contained in the etching vessel by using a concentration detector; and
supplying hydrofluoric acid solution into the etching vessel based on the result of the concentration detection so as to control the hydrofluoric concentration of the etching solution contained in the etching vessel to maintain the concentration of the etching solution contained in the etching vessel constant.

4. The method of manufacturing a liquid crystal display device according to claim 1, wherein the etching includes rocking the etching vessel.

5. The method of manufacturing a liquid crystal display device according to claim 1, wherein the etching includes applying an ultrasonic vibration to the etching solution contained in the etching vessel.

6. The method of manufacturing a liquid crystal display device according to claim 1, wherein forming said at least one assembly includes:
bonding the outer circumferential regions of the glass substrates to each other with an outer circumferential sealing member interposed therebetween, the outer circumferential sealing member having at least one opening for allowing an inner region between the glass substrates to communicate with an outer side of the substrates; and
sealing said at least one opening of the outer circumferential sealing member with a sealing member.

7. The method of manufacturing a liquid crystal display device according to claim 1, further comprising after the etching:
removing the sealing member interposed between the glass substrates by cutting at least that portion of the outer circumferential regions of the two glass substrates in which the sealing member for sealing the air releasing port is arranged; and
cutting the two glass substrates from which the sealing member has been removed into at least one individual liquid crystal display device.

8. The method of manufacturing a liquid crystal display device according to claim 1, wherein each of the two glass substrates of the assembly has an area large enough to form therein a plurality of finished liquid crystal display devices, and the two glass substrates are bonded to each other with a plurality of frame sealing members and the outer circumferential sealing member interposed therebetween so as to form the assembly for forming a plurality of liquid crystal display devices.

9. The method of manufacturing a liquid crystal display device according to claim 1, comprising a batch processing in which a plurality of assemblies each used for forming a plurality of liquid crystal display devices are subjected simultaneously to the etching.
